(19) United States
(12) Patent Application Publication
(10) Pub. No.: US 2025/0258736 A1
(43) Pub. Date: Aug. 14, 2025

(54) FUNCTIONALLY SAFE PIXEL PROCESSING USING EFFICIENT HARDWARE INTEGRITY CHECKS

(71) Applicant: Rivian IP Holdings, LLC, Irvine, CA (US)

(72) Inventors: Vasant Kumar EASWARAN, Frisco, TX (US); Ting LU, Austin, TX (US)

(21) Appl. No.: 19/039,676

(22) Filed: Jan. 28, 2025

Related U.S. Application Data
(60) Provisional application No. 63/552,561, filed on Feb. 12, 2024.

(51) Int. Cl. G06F 11/10; G06F 11/07

(52) U.S. Cl. CPC G06F 11/1004; G06F 11/0733; G06F 11/0739

(57) ABSTRACT

Aspects of the disclosure relate to an integrated circuit that operates an approach for data processing pipeline using end to end hardware integrity checks that may be efficient in memory bandwidth utilization. An apparatus may use safety mechanisms with in-line CRC checksum computation on the sender or receiver side of each stage of the processing pipeline.

### CROSS REFERENCE TO RELATED APPLICATION(S)

The present application claims the benefit of U.S. Provisional Application No. 63/552,561, entitled “FUNCTIONALLY SAFE PIXEL PROCESSING USING EFFICIENT HARDWARE INTEGRITY CHECKS”, filed Feb. 12, 2024, the entirety of which is incorporated herein for reference.

### INTRODUCTION

Automotive Safety Integrity Level (ASIL) is a risk classification system defined by the ISO 26262 standard for the functional safety of road vehicles. ASIL classifies hazards in one of four levels, denoted as A through D, with a fifth additional level for non-hazardous systems or components. ASIL D represents the highest level of risk, while ASIL A represents the lowest risk level.

The standard defines functional safety as “the absence of unreasonable risk due to hazards caused by malfunctioning behavior of electrical or electronic systems.” ASILs establish safety requirements—based on the probability and acceptability of harm—for automotive components to be compliant with ISO 26262.

Systems that include vehicle brakes may require an ASIL-D grade—the highest rigor applied to safety assurance—because of the significant risks associated with their failure. ASIL-B examples are headlights and brake lights, while ASIL C may be for systems that include cruise control. Rear lights are example lights that may be classified with an ASIL-A grade.

Aspects of the subject technology can help to improve the overall cost, reliability, and efficiency of circuits or other electronic components.

### SUMMARY

The present description is generally directed to a processing flow that may be used to implement one or more features of functionally safe processing using hardware integrity checks that may be efficient in memory bandwidth utilization. The disclosed subject matter may use safety mechanisms with in-line CRC checksum computation on the sender or receiver side of each stage of the processing pipeline.

In accordance with one or more aspects of the disclosure, one or more apparatuses may have mechanisms for functionally safe pixel processing using end to end hardware integrity checks of one or more electronic components. A processing pipeline that uses hardware integrity checks may include a first processing component and a second processing component. The first processing component and the second processing component may use cyclic redundancy check (CRC) integrity checks for as data flows through the processing pipeline.

In accordance with one or more aspects of the disclosure, a method may include receiving CRC checksum of outgoing data of a first processing component; receiving CRC checksum of incoming data of a second processing component; determining whether there is a mismatch of the CRC checksum of the outgoing data to the CRC checksum of the incoming data; and based on the determining that there is a mismatch, sending an indication to cease operation of one or more applications. The one or more applications may include an autonomous driving application.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an exemplary processing flow that may be used to implement one or more features of functionally safe processing using hardware integrity checks.

FIG. 2 illustrates an exemplary processing flow that may be used to implement one or more features of functionally safe processing using hardware integrity checks.

FIG. 3 illustrates an exemplary method for hardware integrity checks.

FIG. 4 illustrates an exemplary sequence diagram associated with integrity checks of one or more components.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Automotive Safety Integrity Level (ASIL) rated system-on-chips (SoCs) may have several use cases in which pixels are captured from cameras and then processed through several stages where data is written and read from external memory. The pixel processing blocks, the memory controller, or the memory should be able to support the safety integrity levels required for performing safety critical operations. In many implementations, large amounts of data go in and out of memory and the memory bandwidth needed is often at a premium. Safety mechanisms, such as error checking and correction (ECC), may accesses external memory and therefore may consume a significant amount of memory bandwidth when deployed.

In some implementations, pixel processing pipelines may involve capturing raw pixel data into a SoC via a camera interface (e.g., camera serial interface-CSI), which may then be taken through format conversions to be processed via an image signal processor (ISP), and then through de-warp/scalers before it is processed to derive inferences for computer vision applications. Since each of the image processing (IP) components may be sourced from different suppliers, they typically go in and out of external memory at each stage of the processing pipeline.

In consideration of the typical use of external memory, there are significant memory bandwidth requirements that may be planned for from a system standpoint. In addition, due to the safety requirements for many implementations, ECC is used for read/write to those external memories, which may come at an additional bandwidth penalty to the overall requirements. The disclosed subject matter may use alternate safety mechanisms with in-line cyclic redundancy check (CRC) checksum computation on the sender or receiver side of each stage of the pipeline, which may help avoid the use of ECC or the like on external memories and may reduce the impact on memory bandwidth in a system. The disclosed subject matter may minimize access to external memory, which may help minimize the use of memory bandwidth, while still complying with safety coverage that may comply with standards, such as ASIL.

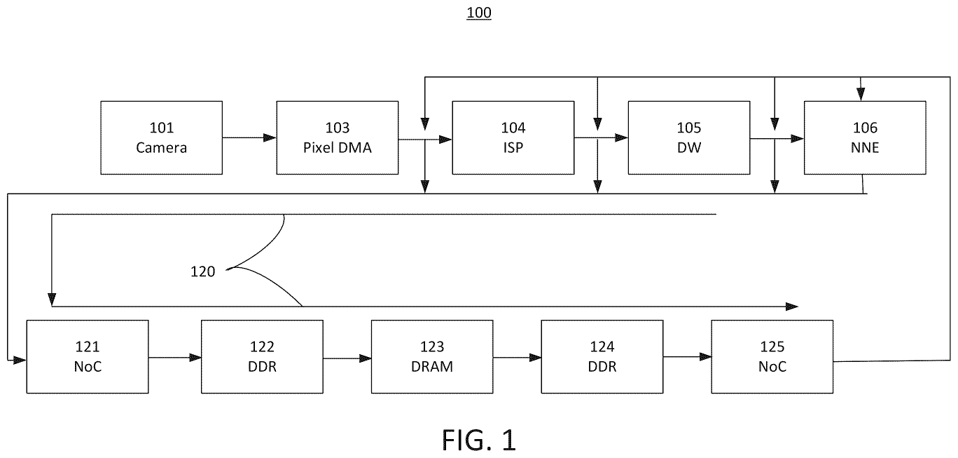

FIG. 1 illustrates an exemplary pixel processing flow 100 that may be used to implement one or more features of functionally safe pixel processing using end to end hardware integrity checks. Pixel processing flow 100 may include components, such as camera 101, pixel direct memory access (DMA) 103, ISP 104, De-warp 105 (e.g., DW200), Neural Network Engine (NNE) 106, CPU 120, network on chip (NoC) 121, double data rate controller (DDR) 122, dynamic random access memory (DRAM) 123, DDR 124, or NoC 125, which may be communicatively connected with each other. Cameral 101 may be connected with pixel DMA 103 via a CSI. In an exemplary implementation, as shown in FIG. 1, data may flow through each of the blocks (in the direction of the arrows) shown. Data may go through several transformations as it flows from one block to another, such as at camera 101, pixel DMA 103, ISP 104, de-warp 105, or NNE 106. For each block, as shown, for error checking and correction (ECC), there is a need to access memory using flow 120 for each transformation and therefore significant memory bandwidth may be used. Although this architecture may meet safety requirements, it may add performance limitations from memory bandwidth standpoint due to support for ECC on memory read/write transactions.

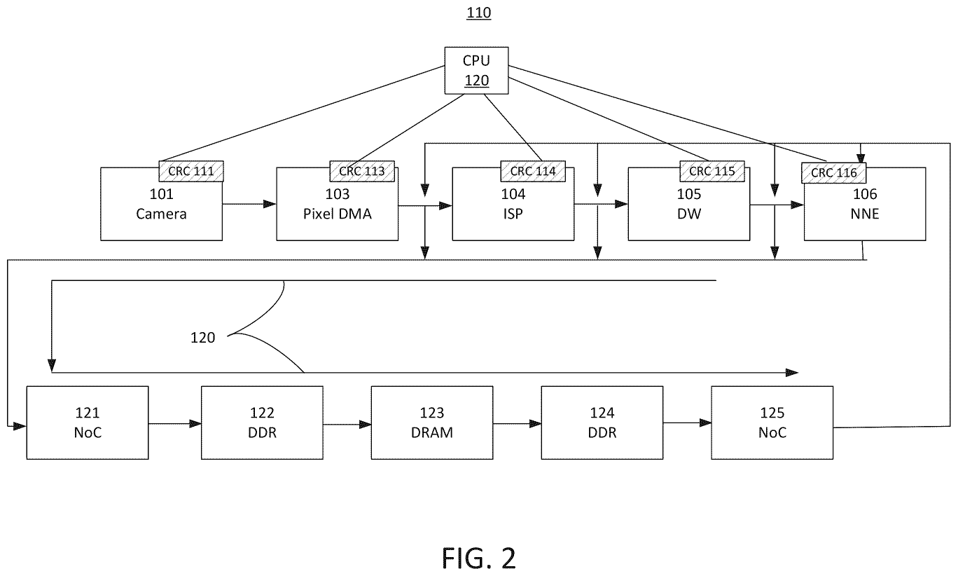

FIG. 2 illustrates an exemplary processing flow 110 that may be used to implement one or more features of functionally safe processing using end to end hardware integrity checks, as disclosed herein. FIG. 2 is similar to FIG. 1 but may use CRC exclusively or dynamically with ECC. Camera 101 may include CRC function 111 (i.e., CRC 111), pixel DMA 103 may include CRC 113, ISP 104 may include CRC 114, DW 105 may include CRC 115, or NNE 106 may include CRC 116. Each component of flow 110 may be communicatively connected with central processing unit (CPU) 120 or a like device. It is contemplated that the components of processing flow 110 may be on a single device or distributed and may be functional components.

In an implementation, CRC is computed locally in-line with each block and therefore there is no additional memory traffic being generated to error check with CRC. Communication with CPU 120 for CRC error detecting does not generally create memory traffic, therefore such a configuration with primary or sole use of CRC for error detection may help significantly reduce memory traffic. In another implementation, CRC may be the primary error detection while ECC may be a secondary error detection that is executed for one or more blocks (e.g., cameral 101, pixel DMA 103, ISP 104, etc.) when there are certain triggers, such as a threshold number of detected CRC errors in a period.

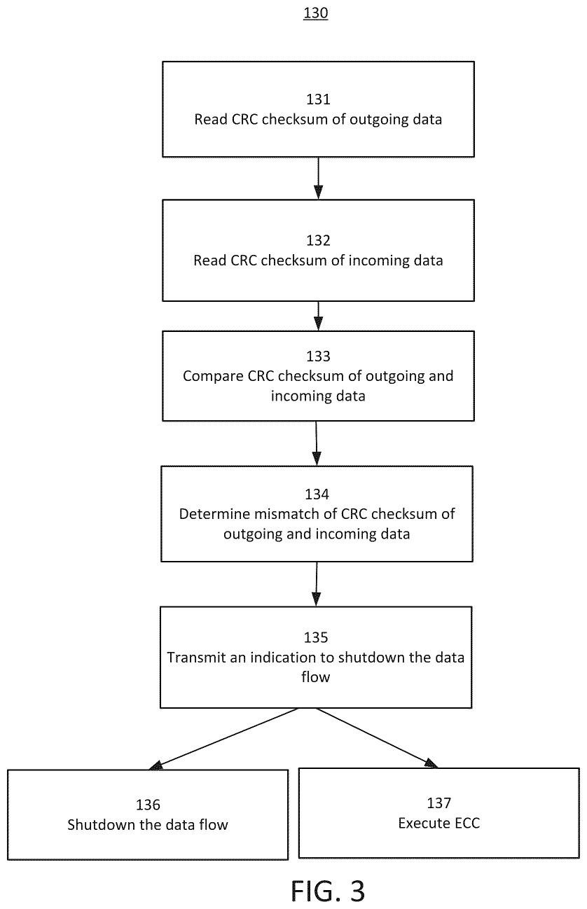

FIG. 3 illustrates an exemplary method 130 for hardware integrity checks. At block 131, a CRC checksum of outgoing data of a first component (e.g., pixel DMA 103), which may be associated with a processing pipeline (e.g., image processing pipeline or pixel processing data flow), may be read by a processor associated with a circuit. The processor may be CPU 120 which may be of a SoC. The CRC may be computed locally on a component of a processing pipeline or in-line in a way that does not generate memory access traffic. CRC checksum may be considered an algorithm used to compute a unique signature value for a stream of pixel data. When expected different junctures (e.g., two different points) in the data flow, the stream of pixel data may be the same, computing CRC checksums at the different junctures allows comparison of values. If they mismatch, then corruption may have taken place along the flow of data between the different junctures.

At block 132, a CRC checksum of incoming data of a second component (e.g., ISP 104), which may be associated with the processing pipeline (e.g., image processing pipeline), may be read by the processor.

At block 133, the processor may compare the CRC checksum of the outgoing data of block 131 to the CRC checksum of the incoming data of block 132 to determine whether there is a mismatch.

At block 134, based on the comparison of block 133, a mismatch may be determined. When a mismatch is a determined, an indication of an error may be transmitted. At block 135, based on the indication of the error, the processor (e.g., CPU 120) may transmit an indication to shutdown the data flow. The indication of the error may be a message that indicates a determined mismatch of CRCs. Block 135 may be executed based on the determined mismatch and if there is no mismatch, then there may be another check of CRCs (e.g., restart at block 131) for the next set of pixel data.

At step 136, based on the indication of the error, no further data (e.g., data of camera 101) would be received or processed for one or more components of the processing pipeline. In an example, the data flow may be shutdown for image processing pipeline 110 (e.g., stop receiving data from camera 101) and some information may not be sent to, received by, or processed by a corresponding vehicle autonomy application. For this example, in essence, the autonomy application may be shut down and there may be a corresponding alert regarding such shutdown of the autonomy application.

Step 137 may be an alternative to or in addition to step 136. When an indication of an error is received and such indication of error has reached a threshold level, then ECC may be executed. The threshold level may be the number or type of CRC errors for one or more components of the processing pipeline or number of shutdowns of particular applications. The ECC may be able to correct single bit errors that occur. The ECC may be activated for one or more components (e.g., pixel DMA 103) and not activated for other components (e.g., ISP 104).

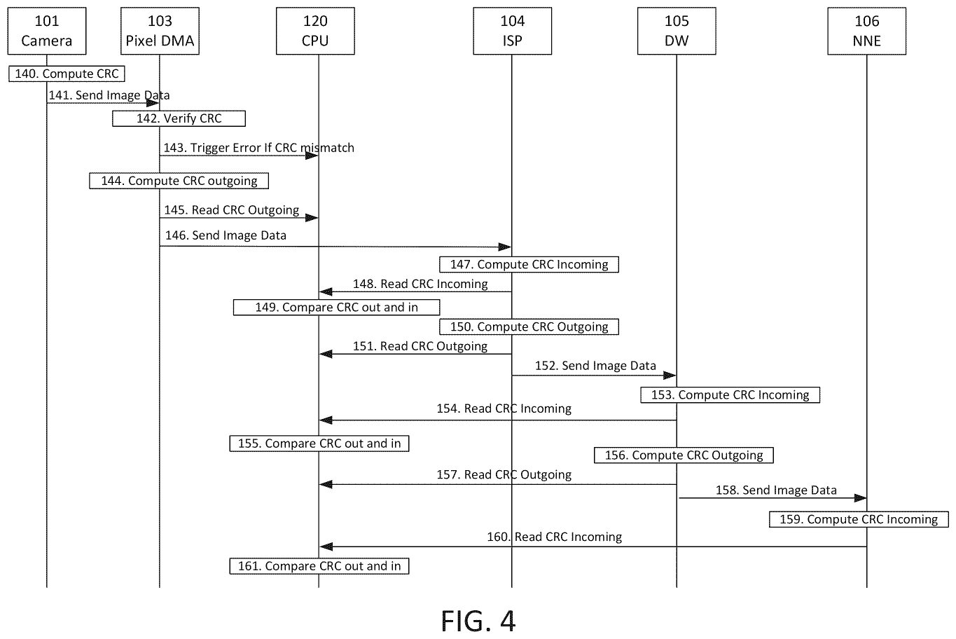

FIG. 4 illustrates an exemplary sequence diagram associated with integrity checks of one or more electronic components. This example implementation is associated with pixel processing. At step 140, camera 101 may compute CRC checksum on image data. At step 141, image data and CRC checksum may be sent over a camera serial interface (CSI) to pixel DMA 103 of the SoC. At step 142, pixel DMA 103 may verify the incoming CRC checksum of step 141. At step 143, if there is an incoming CRC mismatch then an error is triggered and an indication of the error may be sent by pixel DMA 103 to CPU 120. At step 144, a CRC checksum may be computed on outgoing data of pixel DMA 103. At step 145, CPU 120 reads or receives CRC checksum on outgoing data, data which will be subsequently sent in step 146. At step 146, image data may be sent to ISP 104 from pixel DMA 103.

At step 147, ISP 104 may compute CRC checksum of incoming image data of step 146. At step 148, CPU 120 reads or receives CRC checksum on incoming data computed at step 147, data which was sent in step 146. At step 149, CPU 120 compares CRC checksum of outgoing data as received in step 145 with the CRC checksum of incoming data as received in step 148. Whether there is a mismatch in the CRC checksums is determined based on the comparison. At step 150, a CRC checksum may be computed on outgoing data that will be sent from ISP 104 to DW 105. At step 151, CPU 120 may read or receive CRC checksum on outgoing data, data which will be subsequently sent in step 152. At step 152, image data may be sent to DW 105 from ISP 104.

With continued reference to FIG. 4, at step 153, DW 103 may compute CRC checksum of incoming image data of step 152. At step 154, CPU 120 reads or receives CRC checksum on incoming data computed at step 153, data which was sent in step 152. At step 155, CPU 120 compares CRC checksum of outgoing data as received in step 151 with the CRC checksum of incoming data as received in step 154. Whether there is a mismatch in the CRC checksums is determined based on the comparison. At step 156, a CRC checksum may be computed on outgoing data that will be sent from DW 105 to NNE 106. At step 157, CPU 120 may read or receive CRC checksum on outgoing data, data which was sent in step 158. At step 158, image data may be sent to NNE 106 from DW 105.

At step 159, NNE 106 may compute CRC checksum of incoming image data of step 158. At step 160, CPU 120 reads or receives CRC checksum on the incoming data computed at step 159, data which was sent in step 158. At step 161, CPU 120 compares CRC checksum of outgoing data as received in step 156 with the CRC checksum of incoming data as received in step 160. Whether there is a mismatch in the CRC checksums is determined based on the comparison. It is contemplated, but not shown throughout, based on the comparisons herein that may indicate an error, an error indication may be transmitted to CPU 120 to trigger further actions. These further actions may be a display of the error on a display screen or restricting access to one or more features of a vehicle or other devices.

The disclosed subject matter may be directed to functionally safe processing using end to end hardware integrity checks that may comply with Automotive Safety Integrity Level (ASIL). The disclosed subject matter may be used in or with automotive electronic components. Electronic components may be integrated into automobiles, such as an electric vehicle.

The disclosed subject matter may be considered to ensure the use of CRC integrity checks in hardware or software between each pair of successive blocks in the data flow and disable use of ECC on specific regions of memory used for data transfer between those blocks. The disclosed subject matter may result in an improvement in memory bandwidth because of being able to do CRC in-line with the data flow without increasing traffic to the external memory.

To ensure safe processing of data, ASIL-B integrity must be ascertained through the entire pipeline and hence safety mechanisms must be added at each stage as the data flows. Each of the components are designed to ASIL-B requirements and the interfaces connecting the blocks also have safety mechanisms to ensure ASIL-B integrity. From a fault coverage standpoint, although ECC may provide higher diagnostic coverage than CRC, for the safety goals associated with ASIL, ASIL-B integrity may be achieved with CRC as specified in the ISO26262 standard (e.g., more than 90% coverage of single point faults). With reference to ASIL requirements, in terms of functional safety, the criteria are associated with detecting and not necessarily correcting. In an exemplary implementation with CRC, errors may be detected but not necessarily corrected, which may be acceptable from a safety standpoint, as long as the system proceeds to a safe state, such as shutting down an autonomous system application, which would functionally be safe.

Methods, systems, and apparatuses, among other things, as described herein may provide for integrity checks of one or more electronic components. For example, a system may include a processing pipeline that may include a first processing component and a second processing component. The first processing component and the second processing component may use cyclic redundancy check (CRC) integrity checks for a data flow. The first processing component and the second processing component may selectively (e.g., dynamically) use CRC integrity checks or error checking and correction (ECC) for the data flow. The data flow may be an image processing data flow. The processing pipeline may include a camera, a pixel direct memory access (DMA) component, an image signal processor (ISP) component, or de-warp component. The CRC integrity checks or error checking and correction (ECC) for the data flow may be selectively used based on detecting a threshold error level for a period. In an example, based on error checking, an application may be shutdown, which may call for diagnosis of the issue. Diagnosis may include determining the number or type of errors. Thereafter, based on the diagnosis, a switch to ECC or CRC may be determined and implemented. The systems, methods, or apparatuses as disclosed herein may be compliant with ASIL, such as ASIL B. All combinations in this paragraph (including the removal or addition of steps or components) are contemplated in a manner that is consistent with the other portions of the detailed description.

The methods, systems, or apparatuses disclosed herein may be incorporated into electric vehicles or other devices. The methods, systems, or apparatuses disclosed herein may be incorporated into products, such as various feature specific electronic control units (ECUs) to perform autonomous driving, infotainment, or vehicle dynamics/control. In an example, a method may include receiving CRC checksum of outgoing data of a first processing component; receiving CRC checksum of incoming data of a second processing component; determining whether there is a mismatch of the CRC checksum of the outgoing data to the CRC checksum of the incoming data; and based on determining that there is a mismatch, sending an indication to cease operation of one or more applications. The one or more applications may include an autonomous driving application. The method may include sending an indication to use error checking and correction (ECC) for the first processing component. The first processing component or the second processing component may be components of a pixel processing data flow. In an example, the error checking may cause for a shutdown in an application, which may call for diagnosis of the issue and may include determining the number or type of errors. Thereafter, based on the diagnosis, the use of ECC or CRC may be determined and implemented. All combinations in this paragraph and the previous paragraphs (including the removal or addition of steps or components) are contemplated in a manner that is consistent with the other portions of the detailed description.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, or systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method for hardware integrity checks, the method comprising:
receiving, by a processor of a system-on-a-chip (SoC), cyclic redundancy check (CRC) checksum of outgoing data of a first processing component;
receiving, by the processor of the SoC, CRC checksum of incoming data of a second processing component;
determining, by the processor of the SoC, whether there is a mismatch of the CRC checksum of the outgoing data to the CRC checksum of the incoming data; and
based on determining that there is the mismatch of the CRC checksum of the outgoing data to the CRC checksum of the incoming data, transmitting, by the processor of the SoC, an indication of an error.

2. The method of claim 1, further comprising transmitting, based on the indication of the error, an indication to cease operation of one or more applications.

3. The method of claim 2, wherein the one or more applications comprise an autonomous driving application.

4. The method of claim 1, sending an indication to use error checking and correction (ECC) for the first processing component.

5. The method of claim 1, wherein the first processing component comprises a pixel direct memory access (DMA) component.

6. The method of claim 1, wherein the second processing component comprises an image signal processor (ISP) component.

7. The method of claim 1, wherein the first processing component or the second processing component comprises a dewarp component.

8. The method of claim 1, wherein the first processing component and the second processing component are components of a pixel processing data flow.

9. The method of claim 1, wherein the first processing component or the second processing component is integrated into an electric vehicle.

10. A processing pipeline that uses hardware integrity checks, the processing pipeline comprising:
a first image processing component, which uses cyclic redundancy check (CRC) integrity checks for a data flow; and
a second image processing component, which selectively uses CRC integrity checks or error checking and correction (ECC) for the data flow.

11. The processing pipeline of claim 10, wherein the first image processing component comprises a camera.

12. The processing pipeline of claim 10, wherein the first image processing component comprises a pixel direct memory access (DMA) component.

13. The processing pipeline of claim 10, wherein the first image processing component comprises an image signal processor (ISP) component.

14. The processing pipeline of claim 10, wherein the data flow is a pixel processing data flow.

15. The processing pipeline of claim 10, wherein the CRC integrity checks or the ECC for the data flow is selectively used based on being within a threshold error level.

16. The processing pipeline of claim 10, wherein the processing pipeline is integrated into an electric vehicle.

17. The processing pipeline of claim 10, wherein the first image processing component or the second image processing component comprises a dewarp component.

18. A pixel processing pipeline that uses hardware integrity checks, the pixel processing pipeline comprising:
a first processing component, which uses inline cyclic redundancy check (CRC) integrity checks for a data flow; and
a second processing component, which uses inline CRC integrity checks for the data flow.

19. The pixel processing pipeline of claim 18, wherein the first processing component comprises a camera, a pixel direct memory access (DMA) component, or an image signal processor (ISP) component.

20. The pixel processing pipeline of claim 18, wherein the pixel processing pipeline is compliant with Automotive Safety Integrity Level (ASIL) B.
